(19) United States
(12) Patent Application Publication
(10) Pub. No.: US 2022/0084112 A1
(43) Pub. Date: Mar. 17, 2022

(54) SYSTEM FOR TRACKING USER EYE FOCUS FOR ADJUSTING INTERACTIONS WITH A USER

(71) Applicant: BANK OF AMERICA CORPORATION, Charlotte, NC (US)

(72) Inventors: Jo-Ann Taylor, Godalming (GB); Daniel John Nunn, Bracknell (GB); Michael Sbandi, Charlotte, NC (US); Michael Robert Young, Davidson, NC (US)

(73) Assignee: BANK OF AMERICA CORPORATION, Charlotte, NC (US)

(21) Appl. No.: 17/023,475

(22) Filed: Sep. 17, 2020

(51) Int. Cl. G06Q 40/04; G06F 3/01; G06F 40/174; G06Q 40/06

(52) U.S. Cl. CPC G06Q 40/04; G06F 3/013; G06Q 20/206; G06Q 40/06; G06F 40/174

(57) ABSTRACT

Systems, computer program products, and methods are described herein for tracking user eye focus for adjusting interactions with a user. The present invention may be configured to receive, from a user device, image data associated with an item and receive, from the user device, eye-tracking data associated with eye movements of a user while the user is viewing the item. The present invention may be further configured to determine, based on the eye-tracking data, whether the user focused on the item and receive outcome data comprising an action, performed by the user, regarding the item. The present invention may be further configured to determine, based on the outcome data and based on whether the user focused on the item, an attribute of the action by determining whether the user understood the item, whether the user took the action regarding the item impulsively, and/or the like.

### FIELD OF THE INVENTION

The present invention embraces a system for tracking user eye focus for adjusting interactions with a user.

### BACKGROUND

A user may observe an item (e.g., a page of a website, an advertisement, a document, and/or the like) being displayed by a user device, and the user device or another system may determine how long the item was displayed to the user. However, the length of time that the item was displayed to the user may not correspond to an amount of time that the user actively considered the item.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. This summary presents some concepts of one or more embodiments of the present invention in a simplified form as a prelude to the more detailed description that is presented later.

In one aspect, a system for tracking user eye focus for adjusting interactions with a user is presented. The system may include at least one non-transitory storage device and at least one processing device coupled to the at least one non-transitory storage device, where the at least one processing device is configured to receive, from a user device, image data associated with an item, receive, from the user device, eye-tracking data associated with eye movements of a user while the user is viewing the item, determine, based on the eye-tracking data, whether the user focused on the item, receive outcome data including an action, performed by the user, regarding the item, determine, based on the outcome data and based on whether the user focused on the item, an attribute of the action by determining at least one of whether the user understood the item or whether the user took the action regarding the item impulsively, adjust, based on the attribute of the action, information associated with a next interaction with the user, and cause the user device to provide, to the user and during the next interaction, the adjusted information.

In some embodiments, the at least one processing device is configured to determine, based on the image data, characteristics of the item, when determining whether the user focused on the item, determine a characteristic, of the characteristics of the item, on which the user focused, and when adjusting the information associated with the next interaction with the user, adjust the information to include another item having the characteristic on which the user focused.

In some embodiments, the at least one processing device is configured to, when determining whether the user focused on the item, determine an amount of time that a gaze of the user is directed to the item and determine, based on the amount of time satisfying a threshold, that the user focused on the item.

In some embodiments, the at least one processing device is configured to receive the outcome data from at least one of the user device, a point of sale system, or a data structure including information regarding resource distributions associated with the user.

In some embodiments, the at least one processing device is configured to receive, from the user device, location data and, when adjusting the information associated with the next interaction with the user, adjust, based on the attribute of the action and based on the location data, the information associated with the next interaction with the user.

In some embodiments, the at least one processing device is configured to determine, based on the location data, a direction in which the user is moving, determine, based on the direction in which the user is moving, an entity towards which the user is moving, and, when adjusting the information associated with the next interaction with the user, adjust, based on the attribute of the action, based on the direction in which the user is moving, and based on the entity towards which the user is moving, the information associated with the next interaction with the user.

In some embodiments, the item is a description of a product, the action, performed by the user, regarding the item includes the user not purchasing the product, and the at least one processing device is configured to, when determining whether the user focused on the item, determine an amount of time that a gaze of the user is directed to the description of the product and determine, based on the amount of time satisfying a threshold, that the user focused on the description of the product, when adjusting the information associated with the next interaction with the user, identify an advertisement for the product, and when causing the user device to provide, to the user and during the next interaction, the adjusted information, causing the user device to provide the advertisement for the product.

In some embodiments, the item is an input field of a form, the action, performed by the user, regarding the item includes the user providing incorrect information in the input field, and the at least one processing device is configured to, when determining whether the user focused on the item, determine an amount of time that a gaze of the user is directed to the input field and determine, based on the amount of time satisfying a threshold, that the user focused on the input field, when adjusting the information associated with the next interaction with the user, adjusting instructions for completing the input field, and when causing the user device to provide, to the user and during the next interaction, the adjusted information, causing the user device to provide the adjusted instructions for completing the input field.

In some embodiments, the item is a website including characteristics of stocks and the at least one processing device is configured to determine, based on the eye-tracking data, a characteristic of a stock on which the user focused, determine other stocks having the characteristic on which the user focused, and cause the user device to display, to the user, information identifying the other stocks.

In some embodiments, the item is a website including characteristics of stocks and the at least one processing device is configured to determine, based on the eye-tracking data, a characteristic of a stock on which the user focused, where the action, performed by the user, regarding the item includes the user purchasing the stock, determine other stocks having the characteristic on which the user focused, and, when adjusting information associated with the next interaction with the user, adjust the information to include information identifying the other stocks.

In some embodiments, the user is a member of a group of other users and the at least one processing device is configured to provide, to the other users of the group, a notification requesting confirmation that the characteristic on which the user focused is of interest, receive, from one or more of the other users of the group, confirmation that the characteristic on which the user focused is of interest, and provide, based on receiving the confirmation and to the other users of the group, the information identifying the other stocks.

In some embodiments, the item is a website including characteristics of stocks and the at least one processing device is configured to determine, based on the eye-tracking data, a characteristic of a stock on which the user focused, where the action, performed by the user, regarding the item includes the user purchasing the stock, determine, based on the user purchasing the stock, whether the characteristic of the stock complies with a strategy, and provide, to another user and based on determining that the characteristic of the stock does not comply with the strategy, a notification that the user purchased the stock and that the characteristic of the stock does not comply with the strategy.

In some embodiments, the item is a website including characteristics of stocks and the at least one processing device is configured to determine, based on the eye-tracking data, a characteristic of a stock on which the user focused, where the action, performed by the user, regarding the item includes at least one of the user selling the stock or the user not purchasing the stock, determine other stocks having the characteristic on which the user focused, and when adjusting information associated with the next interaction with the user, adjust the information to at least one of include information recommending the user sell the other stocks or remove information identifying the other stocks.

In some embodiments, user is a member of a group of other users and the at least one processing device is configured to provide, to the other users of the group, a notification requesting confirmation that the characteristic on which the user focused is of concern, receive, from one or more of the other users of the group, confirmation that the characteristic on which the user focused is of concern, and provide, based on receiving the confirmation and to the other users of the group, the information identifying the other stocks.

In some embodiments, the item is a website including characteristics of stocks and the at least one processing device is configured to determine, based on the eye-tracking data, a characteristic of a stock on which the user focused, where the action, performed by the user, regarding the item includes the user selling the stock, determine, based on the user selling the stock, whether the characteristic of the stock complies with a strategy, and provide, to another user and based on determining that the characteristic of the stock does not comply with the strategy, a notification that the user sold the stock and that the characteristic of the stock does not comply with the strategy.

In another aspect, a computer program product for tracking user eye focus for adjusting interactions with a user is presented. The computer program product may include a non-transitory computer-readable medium including code causing a first apparatus to receive, from a user device, image data associated with an item, receive, from the user device, eye-tracking data associated with eye movements of a user while the user is viewing the item, determine, based on the eye-tracking data, whether the user focused on the item, receive outcome data including an action, performed by the user, regarding the item, determine, based on the outcome data and based on whether the user focused on the item, an attribute of the action by determining at least one of whether the user understood the item or whether the user took the action regarding the item impulsively, adjust, based on the attribute of the action, information associated with a next interaction with the user, and cause the user device to provide, to the user and during the next interaction, the adjusted information.

In some embodiments, the non-transitory computer-readable medium may include code causing the first apparatus to determine, based on the image data, characteristics of the item, when determining whether the user focused on the item, determine a characteristic, of the characteristics of the item, on which the user focused, and when adjusting the information associated with the next interaction with the user, adjust the information to include another item having the characteristic on which the user focused.

In some embodiments, the non-transitory computer-readable medium may include code causing the first apparatus to, when determining whether the user focused on the item, determine an amount of time that a gaze of the user is directed to the item and determine, based on the amount of time satisfying a threshold, that the user focused on the item.

In some embodiments, the non-transitory computer-readable medium may include code causing the first apparatus to receive the outcome data from at least one of the user device, a point of sale system, or a data structure including information regarding resource distributions associated with the user.

In yet another aspect, a method for tracking user eye focus for adjusting interactions with a user is presented. The method may include receiving, from a user device, image data associated with an item, receiving, from the user device, eye-tracking data associated with eye movements of a user while the user is viewing the item, determining, based on the eye-tracking data, whether the user focused on the item, receiving outcome data including an action, performed by the user, regarding the item, determining, based on the outcome data and based on whether the user focused on the item, an attribute of the action by determining at least one of whether the user understood the item or whether the user took the action regarding the item impulsively, adjusting, based on the attribute of the action, information associated with a next interaction with the user, and causing the user device to provide, to the user and during the next interaction, the adjusted information.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for tracking user eye focus for adjusting interactions with a user, in accordance with an embodiment of the invention; and

FIG. 2 illustrates a process flow for tracking user eye focus for adjusting interactions with a user, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, the data may be related to products, services, and/or the like offered and/or provided by the entity, customers of the entity, other aspect of the operations of the entity, people who work for the entity, and/or the like. As such, the entity may be an institution, group, association, financial institution, establishment, company, union, authority, merchant, service provider, and/or or the like, employing information technology resources for processing large amounts of data.

As used herein, a “user” may be an individual associated with an entity. As such, in some embodiments, the user may be an individual having past relationships, current relationships or potential future relationships with an entity. In some embodiments, a “user” may be an employee (e.g., an associate, a project manager, a manager, an administrator, an internal operations analyst, and/or the like) of the entity and/or enterprises affiliated with the entity, capable of operating systems described herein. In some embodiments, a “user” may be any individual, another entity, and/or a system who has a relationship with the entity, such as a customer, a prospective customer, and/or the like. In some embodiments, a user may be a system performing one or more tasks described herein.

As used herein, a “user interface” may be any device or software that allows a user to input information, such as commands and/or data, into a device, and/or that allows the device to output information to the user. For example, a user interface may include a graphical user interface (GUI) and/or an interface to input computer-executable instructions that direct a processing device to carry out functions. The user interface may employ input and/or output devices to input data received from a user and/or output data to a user. Input devices and/or output devices may include a display, mouse, keyboard, button, touchpad, touch screen, microphone, speaker, LED, light, joystick, switch, buzzer, bell, and/or other devices for communicating with one or more users.

As used herein, a “resource” may generally refer to objects, products, devices, goods, commodities, services, offers, discounts, currency, cash, cash equivalents, rewards, reward points, benefit rewards, bonus miles, cash back, credits, and/or the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, and/or the like.

As used herein, a “source retainer” may generally refer to an account, a system, and/or the like associated with a user and/or a type of resources, such as a checking account, a deposit account, a savings account, a credit account, a rewards account, a rewards points account, a benefit rewards account, a bonus miles account, a cash back account, and/or the like, which may be managed and/or maintained by an entity, such as a financial institution, an electronic resource transfer institution (e.g., a credit card company, a debit card company, a prepaid card company, and/or the like), a credit union, and/or the like.

As used herein, a “distribution” and/or an “allocation” may refer to any transaction, activities, and/or communication between one or more entities, between a user and one or more entities, and/or the like. A resource distribution and/or an allocation of resources may refer to any distribution of resources such as, but not limited to, a payment, processing of funds, purchase of goods or services, a return of goods or services, a payment transaction, a credit transaction, other interactions involving a user's resource or account, and/or the like. In the context of an entity such as a financial institution, a resource distribution and/or an allocation of resources may refer to one or more of a sale of goods and/or services, initiating an automated teller machine (ATM) or online financial session, an account balance inquiry, a rewards transfer, an account money transfer or withdrawal, opening a financial application on a user's computer or mobile device, a user accessing their e-wallet, any other interaction involving the user and/or the user's device that invokes and/or is detectable by the financial institution, and/or the like. In some embodiments, the user may authorize a resource distribution and/or an allocation of resources using a resource distribution instrument (e.g., credit cards, debit cards, checks, digital wallets, currency, loyalty points, and/or the like) and/or resource distribution credentials (e.g., account numbers, resource distribution instrument identifiers, and/or the like). A resource distribution and/or an allocation of resources may include one or more of the following: renting, selling, and/or leasing goods and/or services (e.g., groceries, stamps, tickets, DVDs, vending machine items, and/or the like); making payments to creditors (e.g., paying monthly bills; paying federal, state, and/or local taxes, and/or the like); sending remittances; loading money onto stored value cards (SVCs) and/or prepaid cards; donating to charities; and/or the like. Unless specifically limited by the context, a “resource distribution,” an “allocation of resources,” a “resource transfer,” a “transaction,” a “transaction event,” and/or a “point of transaction event” may refer to any activity between a user, a merchant, an entity, and/or the like. In some embodiments, a resource distribution and/or an allocation of resources may refer to financial transactions involving direct or indirect movement of funds through traditional paper transaction processing systems (e.g., paper check processing) or through electronic transaction processing systems. In this regard, resource distributions and/or allocations of resources may refer to the user initiating a purchase for a product, service, or the like from a merchant. Typical financial resource distribution and/or financial allocations of resources include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points, and/or the like. When describing that resource transfers or transactions are evaluated, such descriptions may mean that the transaction has already occurred, is in the process of occurring or being processed, or has yet to be processed/posted by one or more financial institutions.

As used herein, “resource distribution instrument” may refer to an electronic payment vehicle, such as an electronic credit, debit card, and/or the like, associated with a source retainer (e.g., a checking account, a deposit account, a savings account, a credit account, and/or the like). In some embodiments, the resource distribution instrument may not be a “card” and may instead be account identifying information stored electronically in a user device, such as payment credentials and/or tokens and/or aliases associated with a digital wallet, account identifiers stored by a mobile application, and/or the like.

In some embodiments, the term “module” with respect to an apparatus may refer to a hardware component of the apparatus, a software component of the apparatus, and/or a component of the apparatus that includes both hardware and software. In some embodiments, the term “chip” may refer to an integrated circuit, a microprocessor, a system-on-a-chip, a microcontroller, and/or the like that may either be integrated into the external apparatus, may be inserted and/or removed from the external apparatus by a user, and/or the like.

As used herein, “authentication credentials” may be any information that may be used to identify a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device, and/or the like. The authentication information may be used to authenticate the identity of the user (e.g., determine that the authentication information is associated with an account) and/or determine that the user has authority to access an account or system. In some embodiments, the system may be owned and/or operated by an entity. In such embodiments, the entity may employ additional computer systems, such as authentication servers, to validate and certify resources inputted by a plurality of users within the system. The system may further use authentication servers to certify the identity of users of the system, such that other users may verify the identity of the certified users. In some embodiments, the entity may certify the identity of the users. Furthermore, authentication information and/or permission may be assigned to and/or required from a user, application, computing node, computing cluster, and/or the like to access stored data within at least a portion of the system.

As used herein, an “interaction” may refer to any communication between one or more users, one or more entities or institutions, and/or one or more devices, nodes, clusters, and/or systems within the system environment described herein. For example, an interaction may refer to a transfer of data between devices, an accessing of stored data by one or more nodes of a computing cluster, a transmission of a requested task, and/or the like. In some embodiments, an interaction may refer to an entity, a user, a system, and/or a device providing an advertisement, information, data, a user interface, and/or the like to another entity, another user, another system, and/or another device.

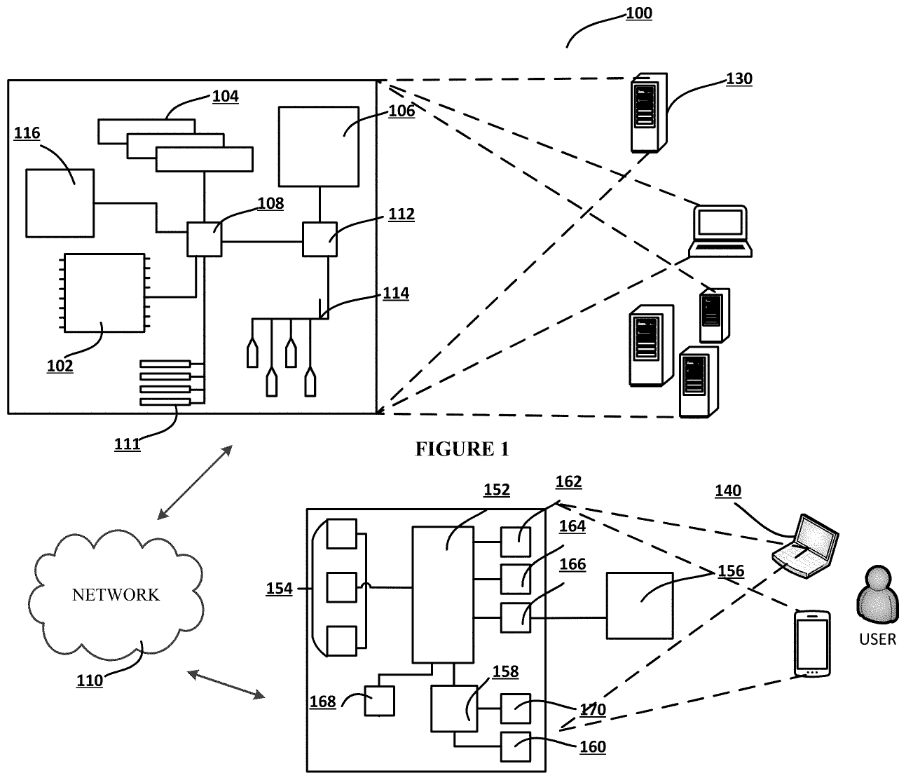

FIG. 1 presents an exemplary block diagram of a system environment 100 for tracking user eye focus for adjusting interactions with a user within a technical environment, in accordance with an embodiment of the invention. FIG. 1 provides a system environment 100 that includes specialized servers and a system communicably linked across a distributive network of nodes required to perform functions of process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device, a non-mobile computing device, and/or the like. The user may be a person who uses the user input system 140 to access, view modify, interact with, and/or the like information, data, images, video, and/or the like. The user may be a person who uses the user input system 140 to execute resource distributions and/or allocations of resources using one or more applications stored thereon. The one or more applications may be configured to communicate with the system 130, execute a resource distribution and/or an allocation of resources, input information onto a user interface presented on the user input system 140, and/or the like. The applications stored on the user input system 140 and the system 130 may incorporate one or more parts of any process flow described herein.

As shown in FIG. 1, the system 130 and the user input system 140 are each operatively and selectively connected to the network 110, which may include one or more separate networks. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology.

In some embodiments, the system 130 and the user input system 140 may be used to implement processes described herein, including user-side and server-side processes for tracking user eye focus for adjusting interactions with a user, in accordance with an embodiment of the present invention. The system 130 may represent various forms of digital computers, such as laptops, desktops, workstations, personal digital assistants, servers, blade servers, mainframes, and/or the like. The user input system 140 may represent various forms of mobile devices, such as personal digital assistants, cellular telephones, smartphones, smart glasses, and/or the like. The components shown here, their connections, their relationships, and/or their functions, are meant to be exemplary only, and are not meant to limit implementations of the inventions described and/or claimed in this document.

In some embodiments, the system 130 may include a processor 102, memory 104, a storage device 106, a high-speed interface 108 connecting to memory 104, high-speed expansion ports 111, and a low-speed interface 112 connecting to low-speed bus 114 and storage device 106. Each of the components 102, 104, 106, 108, 111, and 112 may be interconnected using various buses, and may be mounted on a common motherboard or in other manners as appropriate. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130 may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, and/or the like. The system 130 may be located at a facility associated with the entity and/or remotely from the facility associated with the entity.

The memory 104 may store information within the system 130. In one implementation, the memory 104 may be a volatile memory unit or units, such as volatile random access memory (RAM) having a cache area for the temporary storage of information. In another implementation, the memory 104 may be a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 may be capable of providing mass storage for the system 130. In one aspect, the storage device 106 may be or contain a computer-readable medium, such as a floppy disk device, a hard disk device, an optical disk device, a tape device, a flash memory and/or other similar solid state memory device, and/or an array of devices, including devices in a storage area network or other configurations. A computer program product may be tangibly embodied in an information carrier. The computer program product may also contain instructions that, when executed, perform one or more methods, such as those described herein. The information carrier may be a non-transitory computer-readable or machine-readable storage medium, such as the memory 104, the storage device 106, and/or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application, and allows memory reuse for better utilization of the memory resources when the data sizes are large.

The high-speed interface 108 may manage bandwidth-intensive operations for the system 130, while the low-speed interface 112 and/or controller manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In some embodiments, low-speed interface 112 and/or controller is coupled to storage device 106 and low-speed bus 114 (e.g., expansion port). The low-speed bus 114, which may include various communication ports (e.g., USB, Bluetooth, Ethernet, wireless Ethernet), may be coupled to one or more input/output devices, such as a keyboard, a pointing device, a scanner, and/or a networking device such as a switch or router (e.g., through a network adapter).

The system 130 may be implemented in a number of different forms, as shown in FIG. 1. For example, it may be implemented as a standard server or multiple times in a group of such servers. Additionally, or alternatively, the system 130 may be implemented as part of a rack server system, a personal computer, such as a laptop computer, and/or the like. Alternatively, components from system 130 may be combined with one or more other same or similar systems and the user input system 140 may be made up of multiple computing devices communicating with each other.

FIG. 1 also illustrates a user input system 140, in accordance with an embodiment of the invention. The user input system 140 may include a processor 152, memory 154, an input/output device such as a display 156, a communication interface 158, and a transceiver 160, among other components, such as one or more image sensors. The user input system 140 may also be provided with a storage device, such as a microdrive and/or the like, to provide additional storage. Each of the components 152, 154, 158, and 160, may be interconnected using various buses, and several of the components may be mounted on a common motherboard or in other manners as appropriate.

The processor 152 may be configured to execute instructions within the user input system 140, including instructions stored in the memory 154. The processor 152 may be implemented as a chipset of chips that include separate and multiple analog and/or digital processors. The processor 152 may be configured to provide, for example, for coordination of the other components of the user input system 140, such as control of user interfaces, applications run by user input system 140, and/or wireless communication by user input system 140.

The processor 152 may be configured to communicate with the user through control interface 164 and display interface 166 coupled to a display 156. The display 156 may be, for example, a Thin-Film-Transistor Liquid Crystal Display (TFT LCD) or an Organic Light Emitting Diode (OLED) display, and/or other appropriate display technology. An interface of the display 156 may include appropriate circuitry, and may be configured for driving the display 156 to present graphical and other information to a user. The control interface 164 may receive commands from a user and convert them for submission to the processor 152. In addition, an external interface 168 may be provided in communication with processor 152 to enable near area communication of user input system 140 with other devices. External interface 168 may provide, for example, for wired communication in some implementations, or for wireless communication in other implementations, and multiple interfaces may also be used.

The memory 154 may store information within the user input system 140. The memory 154 may be implemented as one or more of a computer-readable medium or media, a volatile memory unit or units, or a non-volatile memory unit or units. Expansion memory may also be provided and connected to user input system 140 through an expansion interface (not shown), which may include, for example, a Single In Line Memory Module (SIMM) card interface. Such expansion memory may provide extra storage space for user input system 140 and/or may store applications and/or other information therein. In some embodiments, expansion memory may include instructions to carry out or supplement the processes described above and/or may include secure information. For example, expansion memory may be provided as a security module for user input system 140, and may be programmed with instructions that permit secure use of user input system 140. Additionally, or alternatively, secure applications may be provided via the SIMM cards, along with additional information, such as placing identifying information on the SIMM card in a secure manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In some embodiments, a computer program product may be tangibly embodied in an information carrier. The computer program product may contain instructions that, when executed, perform one or more methods, such as those described herein. The information carrier may be a computer-readable or machine-readable medium, such as the memory 154, expansion memory, memory on processor 152, and/or a propagated signal that may be received, for example, over transceiver 160 and/or external interface 168.

In some embodiments, the user may use the user input system 140 to transmit and/or receive information and/or commands to and/or from the system 130. In this regard, the system 130 may be configured to establish a communication link with the user input system 140, whereby the communication link establishes a data channel (wired and/or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, and/or the like.

The user input system 140 may communicate with the system 130 (and one or more other devices) wirelessly through communication interface 158, which may include digital signal processing circuitry. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker (e.g., in a handset) of user input system 140. Such sound may include sound from voice telephone calls, may include recorded sound (e.g., voice messages, music files, and/or the like) and may also include sound generated by one or more applications operating on the user input system 140, and in some embodiments, one or more applications operating on the system 130.

Various implementations of the systems and techniques described here may be realized in digital electronic circuitry, integrated circuitry, specially designed ASICs (application specific integrated circuits), computer hardware, firmware, software, and/or combinations thereof. Such various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and/or at least one output device.

Computer programs (e.g., also referred to as programs, software, applications, code, and/or the like) may include machine instructions for a programmable processor, and may be implemented in a high-level procedural and/or object-oriented programming language, and/or in assembly/machine language. As used herein, the terms “machine-readable medium” and/or “computer-readable medium” may refer to any computer program product, apparatus and/or device (e.g., magnetic discs, optical disks, memory, Programmable Logic Devices (PLDs), and/or the like) used to provide machine instructions and/or data to a programmable processor, including a machine-readable medium that receives machine instructions as a machine-readable signal. The term “machine-readable signal” may refer to any signal used to provide machine instructions and/or data to a programmable processor.

To provide for interaction with a user, the systems and/or techniques described herein may be implemented on a computer having a display device (e.g., a CRT (cathode ray tube), an LCD (liquid crystal display) monitor, and/or the like) for displaying information to the user, a keyboard by which the user can provide input to the computer, and/or a pointing device (e.g., a mouse or a trackball) by which the user can provide input to the computer. Other kinds of devices may be used to provide for interaction with a user as well. For example, feedback provided to the user may be any form of sensory feedback (e.g., visual feedback, auditory feedback, and/or tactile feedback). Additionally, or alternatively, input from the user may be received in any form, including acoustic, speech, and/or tactile input.

The systems and techniques described herein may be implemented in a computing system that includes a back end component (e.g., as a data server), that includes a middleware component (e.g., an application server), that includes a front end component (e.g., a client computer having a graphical user interface or a Web browser through which a user may interact with an implementation of the systems and techniques described here), and/or any combination of such back end, middleware, and/or front end components. Components of the system may be interconnected by any form or medium of digital data communication (e.g., a communication network). Examples of communication networks include a local area network (“LAN”), a wide area network (“WAN”), and/or the Internet.

In some embodiments, computing systems may include clients and servers. A client and server may generally be remote from each other and typically interact through a communication network. The relationship of client and server may arise by virtue of computer programs running on the respective computers and having a client-server relationship to each other.

The embodiment of the system environment 100 illustrated in FIG. 1 is exemplary and other embodiments may vary. As another example, in some embodiments, the system 130 includes more, less, or different components. As another example, in some embodiments, some or all of the portions of the system environment 100, the system 130, and/or the user input system 140 may be combined into a single portion. Likewise, in some embodiments, some or all of the portions of the system environment 100, the system 130, and/or the user input system 140 may be separated into two or more distinct portions.

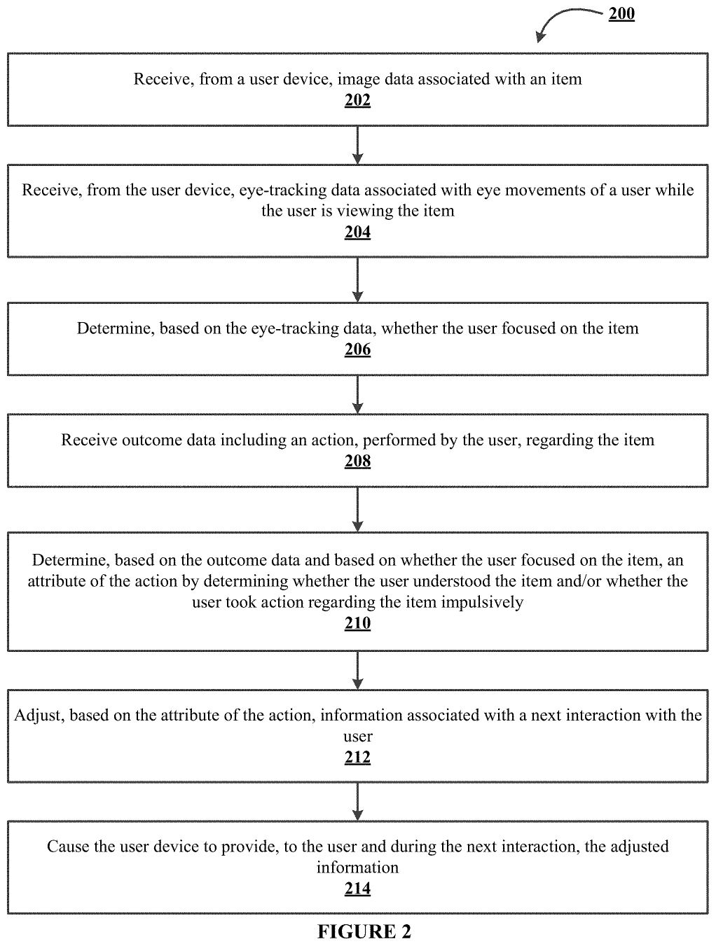

In some embodiments, the system environment 100 may include a user input system and/or a point-of-sale system (e.g., similar to the system 130 and/or the user input system 140) associated with an entity (e.g., a merchant, a service provider, an establishment, a group, an institution, and/or the like), a resource management system (e.g., similar to the system 130) associated with another entity (e.g., a financial institution and/or the like), another user input system (e.g., similar to the user input system 140) associated with a user (e.g., a customer, a prospective customer, and/or the like), and one or more other user input systems (e.g., similar to the user input system 140) associated with one or more other entities (e.g., merchants, service providers, establishments, groups, institutions, and/or the like). For example, a user (e.g., a customer) and an entity (e.g., a merchant) may conduct a resource distribution using a user input system and/or a point-of-sale system associated with the entity and another user input system associated with the user. The user input system and/or the point-of-sale system associated with the entity may communicate with the resource management system to complete the resource distribution. In some embodiments, the user input system and/or the point-of-sale system associated with the entity, the resource management system, and/or the other user input system associated with the user may perform one or more of the steps described herein with respect to the process flow described herein with respect to FIG. 2.

As another example, a user (e.g., a customer) may wear a user input system (e.g., smart glasses and/or the like) and observe an item while the user input system captures images of the item and generates image data. The item may be a physical object, a displayed image (e.g., digitally displayed by another user input system, displayed on a physical object, and/or the like). The user input system may use eye-tracking technology to track the eye movements of the user while the user is viewing items and may generate eye-tracking data based on the eye movements. The user input system may provide the image data and the eye-tracking data to another system that may adjust information associated with interactions with the user based on the image data, the eye-tracking data, other data associated with the user, and/or the like. In some embodiments, the user input system and the other system may perform one or more of the steps described herein with respect to the process flow described herein with respect to FIG. 2.

In some embodiments, the item may be a product and/or a service, information about a product and/or a service, and/or the like, and the other system may adjust advertisements provided to the user (e.g., by the user device, via notifications, by electronic displays for viewing by the user, and/or the like). For example, the other system may adjust the advertisements provided to the user to provide the user with additional information about the product and/or the service, information about related products and/or services, and/or the like.

In some embodiments, the item may be a form including one or more input fields (e.g., a loan application, a registration form, a survey, and/or the like), and the other system may adjust instructions provide to the user to complete the form. For example, the other system may adjust the instructions provided to the user to further explain one or more of the input fields, to increase a likelihood that the user completes one or more of the input fields correctly, and/or the like. In some embodiments, the other system may adjust the instructions based on image data, eye-tracking data, and other data associated with other users that previously viewed and/or completed the form.

In some embodiments, the item may be a website, application, portal, and/or the like for viewing, trading, buying, selling, and/or the like stocks as well as providing information regarding characteristics of stocks. For example, the other system may adjust stocks recommended for the user to buy, sell, review, and/or the like based on characteristics of stocks the user focused on, whether the user bought, sold, further researched stocks, and/or the like. In some embodiments, the other system may adjust stocks displayed to the user based on image data, eye-tracking data, and other data associated with other users associated with the user (e.g., other users on a team with the user, other users in a group with the user, and/or the like).

As noted above, a user may observe an item (e.g., a page of a website, an advertisement, a document, and/or the like) being displayed by a user device, and the user device or another system may determine how long the item was displayed to the user. However, the length of time that the item was displayed to the user may not correspond to an amount of time that the user actively considered the item. Accordingly, adjusting future interactions with a user based on the length of time that the item was displayed to the user may result in inefficient, incorrect, ineffective, and/or inaccurate adjustments to the future interactions. Such inefficient, incorrect, ineffective, and/or inaccurate adjustments reduce the efficacy of the future interactions and consumes resources, such as computing resources (e.g., processing resources, memory resources, power resources, communication resources, and/or the like), network resources, financial resources, and/or the like.

Some embodiments described herein provide a system, a computer program product, and/or a method for tracking user eye focus for adjusting interactions with a user. For example, a system may be configured to receive, from a user device, image data associated with an item and receive, from the user device, eye-tracking data associated with eye movements of a user while the user is viewing the item. The system may be further configured to determine, based on the eye-tracking data, whether the user focused on the item and receive outcome data including an action, performed by the user, regarding the item. The system may be further configured to determine, based on the outcome data and based on whether the user focused on the item, an attribute of the action by determining whether the user understood the item, whether the user took the action regarding the item impulsively, and/or the like. In some embodiments, the system may be further configured to adjust, based on the attribute of the action, information associated with a next interaction with the user and cause the user device to provide, to the user and during the next interaction, the adjusted information. By determining whether the user focused on the item, the system may determine an amount of time that the user actively considered the item, which increases efficacy of the next interaction and conserves resources (e.g., computing resources, such as processing resources, memory resources, power resources, communication resources, and/or the like, network resources, financial resources, and/or the like) that would otherwise be consumed by adjusting future interactions with the user based on the length of time that the item was displayed to the user. Additionally, or alternatively, by determining whether the user understood the item and/or whether the user took the action regarding the item impulsively, the system may further increase the efficacy of the next interaction and further conserve resources.

FIG. 2 illustrates a process flow 200 for tracking user eye focus for adjusting interactions with a user within a technical environment, in accordance with an embodiment of the invention. In some embodiments, a system (e.g., similar to one or more of the systems described herein with respect to FIG. 1) may perform one or more of the steps of process flow 200.

As shown in block 202, the process flow 200 may include receiving, from a user device, image data associated with an item. In some embodiments, the user device may include one or more image sensors (e.g., camera sensors and/or the like) for capturing images and/or video of items the user is viewing and providing the captured images as image data. For example, the user device may be a wearable device (e.g., smart glasses) including one or more image sensors for capturing images and/or video of a field of view of the user and generating image data. A system (e.g., similar to one or more of the systems described herein with respect to FIG. 1) may receive the image data, and, in some embodiments, the system may process the image data to identify one or more items in the image data. For example, the system may use one or more image processing techniques to locate and/or identify items in the field of view of the user.

As shown in block 204, the process flow 200 may include receiving, from the user device, eye-tracking data associated with eye movements of a user while the user is viewing the item. In some embodiments, the user device may include one or more image sensors (e.g., camera sensors and/or the like) for capturing images and/or video of the eyes of the user and providing eye-tracking data. For example, the user device may be a wearable device (e.g., smart glasses) including one or more images sensors for capturing images and/or video of the eyes of the user and generating eye-tracking data.

Additionally, or alternatively, the user device may be a wearable device (e.g., smart glasses) including one or more image sensors for capturing images and/or video of a field of view of the user and one or more image sensors for capturing images and/or video of the eyes of the user. For example, a first image sensor and/or a first set of image sensors may be oriented in a first direction toward a field of view of the user, and a second image sensor and/or a second set of image sensors may be oriented in a second direction toward the eyes of the user. In some embodiments, the first direction and second direction may be substantially opposite directions.

In some embodiments, the eye-tracking data may be image data of the eyes of the user, and a system (e.g., similar to one or more of the systems described herein with respect to FIG. 1) may receive the image data of the eyes of the user and may process the image data to identify the eyes of the user in the image data and movements of the eyes over a period of time. For example, the system may use one or more image processing techniques to locate and/or identify the eyes of the user and determine movement of the eyes over time.

Additionally, or alternatively, the user device may process image data of the eyes of the user to identify the eyes of the user in the image data and movements of the eyes over time and generate the eye-tracking data. For example, the user device may track the eyes of the user over time to generate the eye-tracking data and provide the eye-tracking data to the system.

As shown in block 206, the process flow 200 may include determining, based on the eye-tracking data, whether the user focused on the item. For example, a system (e.g., similar to one or more of the systems described herein with respect to FIG. 1) may determine, based on the eye-tracking data, whether the user focused on the item.

In some embodiments, the process flow 200 may include, when determining whether the user focused on the item, determining an amount of time that a gaze of the user is directed to the item and determining, based on the amount of time satisfying a threshold, that the user focused on the item. For example, the threshold may be a predetermined amount of time. Additionally, or alternatively, the threshold may be an amount of time that is based on a type of the item, a type of device displaying the item, a location of the item, a time of day when the user is viewing the item, and/or the like.

As shown in block 208, the process flow 200 may include receiving outcome data including an action, performed by the user, regarding the item. For example, a system (e.g., similar to one or more of the systems described herein with respect to FIG. 1) may receive outcome data including an action, performed by the user, regarding the item. In some embodiments, the outcome data may include data associated with the action, performed by the user, regarding the item, and the system may process the outcome data to determine the action performed, by the user, regarding the item. Additionally, or alternatively, the outcome data may include data associated with multiple actions performed, by the user, regarding a plurality of items, and the system may process the outcome data to identify each action and, for each action, an item with respect to which the action was performed. In some embodiments, receiving the outcome data may include receiving the outcome data from the user device, a point of sale system, a data structure including information regarding resource distributions associated with the user, and/or the like.

As shown in block 210, the process flow 200 may include determining, based on the outcome data and based on whether the user focused on the item, an attribute of the action by determining whether the user understood the item and/or whether the user took the action regarding the item impulsively. For example, a system (e.g., similar to one or more of the systems described herein with respect to FIG. 1) may determine, based on the outcome data and based on whether the user focused on the item, an attribute of the action by determining whether the user understood the item and/or whether the user took the action regarding the item impulsively. In some embodiments, exemplary attributes of actions may include that the action was taken while the user was concentrating, that the action was taken while the user understood the item, that the action was taken while the user did not understand the item, that the action was taken with little consideration, that the action was taken after focusing on and/or considering other items, and/or the like.

As shown in block 212, the process flow 200 may include adjusting, based on the attribute of the action, information associated with a next interaction with the user. For example, a system (e.g., similar to one or more of the systems described herein with respect to FIG. 1) may adjust, based on the attribute of the action, information associated with a next interaction with the user. In some embodiments, the information may include an advertisement, an offer, a set of instructions, a list of items, and/or the like. Additionally, or alternatively, the next interaction with the user may include one or more future interactions with the user, such as the user entering a location, the user viewing a display, the user viewing a webpage, the user opening an application, the user accessing a system, and/or the like. In some embodiments, adjusting the information associated with the next interaction may include changing the information from first information to second information, selecting between two or more options for the next interaction, removing a subset of information and/or options from the information, changing a subset of information and/or options within the information, and/or the like.

As shown in block 214, the process flow 200 may include causing the user device to provide, to the user and during the next interaction, the adjusted information. For example, a system (e.g., similar to one or more of the systems described herein with respect to FIG. 1) may cause the user device to provide, to the user and during the next interaction, the adjusted information. In some embodiments, the system may cause the user device to provide the adjusted information by causing the user device to display the adjusted information, providing a notification (e.g., a message, an email, an alert, and/or the like) to the user device, turning on the user device.

Additionally, or alternatively, the system may cause another device to provide the adjusted information to the user. For example, the system may cause another device with an electronic display to display the adjusted information to the user when the user is in a location and/or positioned such that the user may view the electronic display.

In some embodiments, the process flow may include determining, based on the image data, characteristics of the item (e.g., a type of the item, a color of the item, a size of the item, a use of the item, a manufacturer of the item, a brand of the item, a model of the item, a price of the item, a purpose of the item, a metric associated with the item, and/or the like). The process flow may further include, when determining whether the user focused on the item, determining a characteristic, of the characteristics of the item, on which the user focused. In some embodiments, the process flow may further include when adjusting the information associated with the next interaction with the user, adjusting the information to include another item having the characteristic on which the user focused. For example, if the user focused on the brand of the item, the system may adjust the information associated with the next interaction with the user to include another item of the same brand. As another example, if the user focused on a particular metric of a stock, the system may adjust the information associated with the next interaction to include one or more other stocks with the same and/or similar values for the particular metric.

In some embodiments, the process flow 200 may include receiving, from the user device, location data and, when adjusting the information associated with the next interaction with the user, adjusting, based on the attribute of the action and based on the location data, the information associated with the next interaction with the user. Additionally, or alternatively, the process flow 200 may include determining, based on the location data, a direction in which the user is moving, determining, based on the direction in which the user is moving, an entity towards which the user is moving, and when adjusting the information associated with the next interaction with the user, adjusting, based on the attribute of the action, based on the direction in which the user is moving, and based on the entity towards which the user is moving, the information associated with the next interaction with the user. For example, if the user recently focused on an advertisement for clothing, electronic displays near the user are configured to display either advertisements for clothing or advertisements for cars, and the user is moving towards one or more retail stores and/or department stores, the system may adjust the electronic displays to display the advertisements for clothing.

In some embodiments, the item may be a description of a product and the action performed by the user regarding the item may include the user not purchasing the product. In such embodiments, the process flow 200 may include when determining whether the user focused on the item, determining an amount of time that a gaze of the user is directed to the description of the product and determining, based on the amount of time satisfying a threshold, that the user focused on the description of the product. The process flow 200 may further include, when adjusting the information associated with the next interaction with the user, identifying an advertisement for the product and, when causing the user device to provide, to the user and during the next interaction, the adjusted information, causing the user device to provide the advertisement for the product. For example, if the user recently focused on a description of a product but did not purchase the product, the system may cause the user device and/or another device within the field of view of the user to display an advertisement for the product.

In some embodiments, the item may be an input field of a form and the action, performed by the user, regarding the item may include the user providing incorrect information in the input field. In such embodiments, the process flow 200 may include, when determining whether the user focused on the item, determining an amount of time that a gaze of the user is directed to the input field and determining, based on the amount of time satisfying a threshold, that the user focused on the input field. In such embodiments, the process flow 200 may include, when adjusting the information associated with the next interaction with the user, adjusting instructions for completing the input field and, when causing the user device to provide, to the user and during the next interaction, the adjusted information, causing the user device to provide the adjusted instructions for completing the input field. For example, based on the user and/or other users focusing on an input field of a form but providing incorrect information, the system may adjust instructions provided for completing the input field in an effort to increase a likelihood that users correctly complete the input field.

In some embodiments, the item may be a website including characteristics of stocks. For example, the user may access, using the user device, a website, an application, a portal, a platform, and/or the like to view information regarding a plurality of stocks, buy, sell, and/or trade stocks, provide information regarding stocks, and/or the like. In such embodiments, the process flow 200 may include determining, based on the eye-tracking data, a characteristic of a stock on which the user focused, determining other stocks having the characteristic on which the user focused, and causing the user device to display, to the user, information identifying the other stocks. In this way, the system may assist the user with identifying stocks with similar characteristics, which conserves computing resources and/or network resources that would otherwise be consumed by the user manually examining characteristics of other stocks.

Additionally, or alternatively, the action, performed by the user, regarding the item may include the user purchasing the stock. In such embodiments, the process flow 200 may include determining, based on the eye-tracking data, a characteristic of a stock on which the user focused, determining other stocks having the characteristic on which the user focused, and, when adjusting information associated with the next interaction with the user, adjusting the information to include information identifying the other stocks. In this way, the system may assist the user with identifying stocks with characteristics similar to a stock which the user purchased, which conserves computing resources and/or network resources that would otherwise be consumed by the user manually examining characteristics of other stocks.

In some embodiments, the user may be a member of a group of other users (e.g., employees of an entity, a team, a trading team, an association, and/or the like). In such embodiments, the process flow 200 may include providing, to the other users of the group, a notification (e.g., a message, an email, an alert, and/or the like) requesting confirmation that the characteristic on which the user focused is of interest, receiving, from one or more of the other users of the group, confirmation that the characteristic on which the user focused is of interest, and providing, based on receiving the confirmation and to the other users of the group, the information identifying the other stocks. In this way, the system may assist a group of users with identifying stocks with characteristics similar to a stock one of the users of the group purchased, which conserves computing resources and/or network resources that would otherwise be consumed by the each user of the group manually examining characteristics of other stocks. Furthermore, the system may permit the group of users to act in a unified manner in real-time and/or near real-time, which may improve an outcome for the group. Finally, by requesting confirmation from other users of the group, the system may conserve computing resources and/or network resources that would otherwise be consumed by instructing the other users of the group to purchase the stock when the stock does not have a characteristic of interest.

In some embodiments, the item may be a website including characteristics of stocks, and the action, performed by the user, regarding the item may include the user purchasing a stock. In such embodiments, the process flow may include determining, based on the eye-tracking data, a characteristic of a stock on which the user focused, determining, based on the user purchasing the stock, whether the characteristics of the stock comply with a strategy (e.g., a group strategy, a team strategy, an entity strategy, a compliance protocol, and/or the like), and providing, to another user and based on determining that the characteristics of the stock do not comply with the strategy, a notification (e.g., a message, an email, an alert, and/or the like) that the user purchased the stock and that the characteristics of the stock do not comply with the strategy. For example, based on a user purchasing a stock, the system may determine whether one or more characteristics of the stock comply with a group strategy, a team strategy, a compliance strategy, and/or the like, and, if one or more characteristics of the stock do not comply, the system may notify another user (e.g., another member of the team, another member of the group, a compliance officer, a group and/or team leader, and/or the like) regarding the stock purchase.

In some embodiments, the item may be a website including characteristics of stocks, and the action, performed by the user, regarding the item may include the user selling a stock, the user not purchasing a stock, and/or the like. In such embodiments, the process flow 200 may include determining, based on the eye-tracking data, a characteristic of a stock on which the user focused, determining other stocks having the characteristic on which the user focused, and, when adjusting information associated with the next interaction with the user, adjusting the information to include information recommending the user sell the other stocks, to remove information identifying the other stocks, and/or the like. For example, based on the user focusing on a characteristic and/or a set of characteristics of a stock and then selling the stock, not purchasing the stock, and/or the like, the system may remove (e.g., from a displayed list of stocks, from a group of stocks to be displayed to the user, and/or the like) other stocks having the same and/or a similar characteristic and/or set of characteristics as the stock the user sold, did not purchase, and/or the like. As another example, based on the user focusing on a characteristic and/or a set of characteristics of a stock and then selling the stock, not purchasing the stock, and/or the like, the system may identify other stocks owned by the user, owned by an entity associated with the user, owned by a portfolio managed by the user, owned by a fund managed by the user, and/or the like having the same and/or a similar characteristic and/or set of characteristics as the stock the user sold, did not purchase, and/or the like and may provide a notification to the user suggesting, recommending, and/or the like that the user sell the other stocks. In this way, the system may assist the user with identifying stocks with characteristics similar to a stock which the user sold, did not purchase, and/or the like, which conserves computing resources and/or network resources that would otherwise be consumed by the user manually examining characteristics of other stocks. Furthermore, the system may assist the user with identifying owned stocks having similar characteristics that potentially should be sold, which conserves computing resources and/or network resources that would otherwise be consumed by the user manually examining characteristics of the owned stocks.

In some embodiments, the item may be a website including characteristics of stocks, the action, performed by the user, regarding the item may include the user selling a stock, the user not purchasing a stock, and/or the like, and the user may be a member of a group of other users. In such embodiments, the process flow 200 may include determining other stocks having a characteristic on which the user focused, providing, to the other users of the group, a notification requesting confirmation that the characteristic on which the user focused is of concern, receiving, from one or more of the other users of the group, confirmation that the characteristic on which the user focused is of concern, and providing, based on receiving the confirmation and to the other users of the group, information identifying the other stocks. For example, based on a user focusing on a characteristic and/or a set of characteristics of a stock and then selling a stock, the user not purchasing a stock, and/or the like, the system may identify other stocks having the same and/or similar characteristics and/or sets of characteristics, provide a notification to other users of the group requesting that the characteristic and/or the set of characteristics is of concern (e.g., unfavorable, undesirable, problematic, lacks value, associated with a negative forecast, and/or the like), receive confirmation that the characteristic and/or the set of characteristics is of concern, and provide information identifying the other stocks having the same and/or similar characteristics and/or sets of characteristics to the other members of the group. In this way, the system may assist the group of users with identifying stocks with characteristics similar to a stock which the user sold, did not purchase, and/or the like, which conserves computing resources and/or network resources that would otherwise be consumed by each user manually examining characteristics of other stocks. Furthermore, the system may assist the group of users with identifying stocks having similar characteristics that potentially should be sold, not purchased, and/or the like, which conserves computing resources and/or network resources that would otherwise be consumed by each user manually examining characteristics of the stocks.

In some embodiments, the item may be a website including characteristics of stocks, and the action, performed by the user, regarding the item may include the user selling a stock. In such embodiments, the process flow 200 may include determining, based on eye-tracking data, a characteristic of a stock on which the user focused, determining, based on the user selling the stock, whether characteristics of the stock comply with a strategy (e.g., a group strategy, a team strategy, an entity strategy, a compliance protocol, and/or the like), and providing, to another user and based on determining that the characteristics of the stock do not comply with the strategy, a notification (e.g., a message, an email, an alert, and/or the like) that the user sold the stock and that the characteristics of the stock do not comply with the strategy. For example, based on a user selling a stock, the system may determine whether one or more characteristics of the stock comply with a group strategy, a team strategy, a compliance strategy, and/or the like, and, if one or more characteristics of the stock do not comply, the system may notify another user (e.g., another member of the team, another member of the group, a compliance officer, a group and/or team leader, and/or the like) regarding the stock sale.

As described herein, in some embodiments, the system may combine the eye-tracking data with market information sites (e.g., equity trading screens and/or the like) to determine which characteristics of stocks are most interesting to users (e.g., traders). By determining which characteristic and/or set of characteristics the user is examining in depth, the system may identify other stocks with the characteristic and/or the set of characteristics and present the other stocks to the user for consideration. Additionally, or alternatively, if the user is concerned by a characteristic and/or a set of characteristics of a stock, the user (e.g., via a user interface, such as a graphical user interface) may choose to remove all stocks with that characteristic and/or that set of characteristics from consideration.

As also described herein, in some embodiments, the system may combine the eye-tracking data with web page data (e.g., a loan application form) to determine how intuitive and/or confusing a form and/or document is. For example, the system may determine an amount of time spent on each input field and accuracy of information provided by a user. Based on the information, an entity (e.g., an entity providing the form) may improve the form (e.g., by clarifying information, by improving instructions, and/or the like).

As also described herein, in some embodiments, the system may combine the eye-tracking data with data from one or more point of sale system to determine shopping habits, preferences, and/or the like of a user and provide, to the user, more appropriate, effective, and/or the like marketing and/or advertising (e.g., for items which the user focuses on for a greater amount of time, for items which the user considers for a greater amount of time, and/or the like).

Although descriptions of FIG. 2 include a system performing one or more of the steps of process flow 200, in some embodiments, the user device, with or without assistance from another system, may perform one or more of the steps of process flow 200. For example, the user device may capture and/or generate the image data associated with the item, capture and/or generate the eye-tracking data associated with eye movements of the user while the user is viewing the item, perform one or more of the other steps of process flow 200, and provide, to the user and during the next interaction, the adjusted information. Additionally, or alternatively, the user device may provide data and/or information to another system and perform one or more of the steps of process flow 200 in conjunction with the other system (e.g., in real-time or near real-time).

In some embodiments, the process flow 200 may include performing one or more of the functions described herein using machine learning and/or a machine learning model. For example, the system may provide characteristics of items, eye-tracking data, outcome data, attributes of actions performed by users, characteristics of interactions, and/or the like to a machine learning model trained (e.g., using historical data) to output adjusted information, additional information, information to be removed, and/or the like associated with a next interaction.

In some embodiments, the system may be configured to implement any of the following applicable machine learning algorithms either singly or in combination: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system can additionally or alternatively leverage a probabilistic module, heuristic module, deterministic module, or any other suitable module leveraging any other suitable computation method, machine learning method or combination thereof. However, any suitable machine learning approach can otherwise be incorporated in the system. Further, any suitable model (e.g., machine learning, non-machine learning, etc.) can be used in generating data relevant to the system. In some embodiments, the one or more machine learning algorithms may be predictive modeling algorithms configured to use data and statistics to predict outcomes with forecasting models.

In some embodiments, the machine learning model may be generated by training on data regarding characteristics of items, eye-tracking, outcomes, attributes of actions performed by users, characteristics of interactions, and/or the like over a predetermined past period of time. In doing so, the system may be configured to determine adjusted information, additional information, information to be removed, and/or the like associated with a next interaction. In some embodiments, the one or more machine learning algorithms may be used to calculate the likelihood of the user performing an action during the next interaction resulting in a positive outcome (e.g., a purchase, input accurate information, a sale, an acceptance of an offer, and/or the like), and whether the likelihood satisfies a threshold.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for tracking user eye focus for adjusting interactions with a user, the system comprising:
at least one non-transitory storage device; and
at least one processing device coupled to the at least one non-transitory storage device, wherein the at least one processing device is configured to:
receive, from a user device, image data associated with an item;
receive, from the user device, eye-tracking data associated with eye movements of a user while the user is viewing the item;
determine, based on the eye-tracking data, whether the user focused on the item;
receive outcome data comprising an action, performed by the user, regarding the item;
determine, based on the outcome data and based on whether the user focused on the item, an attribute of the action by determining at least one of:
whether the user understood the item; or
whether the user took the action regarding the item impulsively;
adjust, based on the attribute of the action, information associated with a next interaction with the user; and
cause the user device to provide, to the user and during the next interaction, the adjusted information.

2. The system of claim 1, wherein the at least one processing device is further configured to:
determine, based on the image data, characteristics of the item;
when determining whether the user focused on the item, determine a characteristic, of the characteristics of the item, on which the user focused; and
when adjusting the information associated with the next interaction with the user, adjust the information to include another item having the characteristic on which the user focused.

3. The system of claim 1, wherein the at least one processing device is configured to, when determining whether the user focused on the item:
determine an amount of time that a gaze of the user is directed to the item; and
determine, based on the amount of time satisfying a threshold, that the user focused on the item.

4. The system of claim 1, wherein the at least one processing device is configured to receive the outcome data from at least one of:
the user device;
a point of sale system; or
a data structure comprising information regarding resource distributions associated with the user.

5. The system of claim 1, wherein the at least one processing device is configured to:
receive, from the user device, location data; and
when adjusting the information associated with the next interaction with the user, adjust, based on the attribute of the action and based on the location data, the information associated with the next interaction with the user.

6. The system of claim 5, wherein the at least one processing device is configured to:
determine, based on the location data, a direction in which the user is moving;
determine, based on the direction in which the user is moving, an entity towards which the user is moving; and
when adjusting the information associated with the next interaction with the user, adjust, based on the attribute of the action, based on the direction in which the user is moving, and based on the entity towards which the user is moving, the information associated with the next interaction with the user.

7. The system of claim 1, wherein the item is a description of a product;
wherein the action, performed by the user, regarding the item comprises the user not purchasing the product;
wherein the at least one processing device is configured to:
when determining whether the user focused on the item:
determine an amount of time that a gaze of the user is directed to the description of the product; and
determine, based on the amount of time satisfying a threshold, that the user focused on the description of the product;
when adjusting the information associated with the next interaction with the user, identify an advertisement for the product; and
when causing the user device to provide, to the user and during the next interaction, the adjusted information, cause the user device to provide the advertisement for the product.

8. The system of claim 1, wherein the item is an input field of a form;
wherein the action, performed by the user, regarding the item comprises the user providing incorrect information in the input field; and
wherein the at least one processing device is configured to:
when determining whether the user focused on the item:
determine an amount of time that a gaze of the user is directed to the input field; and
determine, based on the amount of time satisfying a threshold, that the user focused on the input field;
when adjusting the information associated with the next interaction with the user, adjust instructions for completing the input field; and
when causing the user device to provide, to the user and during the next interaction, the adjusted information, cause the user device to provide the adjusted instructions for completing the input field.

9. The system of claim 1, wherein the item is a website comprising characteristics of stocks; and
wherein the at least one processing device is configured to:
determine, based on the eye-tracking data, a characteristic of a stock on which the user focused;
determine other stocks having the characteristic on which the user focused; and
cause the user device to display, to the user, information identifying the other stocks.

10. The system of claim 1, wherein the item is a website comprising characteristics of stocks; and
wherein the at least one processing device is configured to:
determine, based on the eye-tracking data, a characteristic of a stock on which the user focused, wherein the action, performed by the user, regarding the item comprises the user purchasing the stock;
determine other stocks having the characteristic on which the user focused; and
when adjusting information associated with the next interaction with the user, adjust the information to comprise information identifying the other stocks.

11. The system of claim 10, wherein the user is a member of a group of other users; and
wherein the at least one processing device is configured to:
provide, to the other users of the group, a notification requesting confirmation that the characteristic on which the user focused is of interest;
receive, from one or more of the other users of the group, confirmation that the characteristic on which the user focused is of interest; and
provide, based on receiving the confirmation and to the other users of the group, the information identifying the other stocks.

12. The system of claim 1, wherein the item is a website comprising characteristics of stocks; and
wherein the at least one processing device is configured to:
determine, based on the eye-tracking data, a characteristic of a stock on which the user focused, wherein the action, performed by the user, regarding the item comprises the user purchasing the stock;
determine, based on the user purchasing the stock, whether characteristics of the stock comply with a strategy; and
provide, to another user and based on determining that the characteristics of the stock do not comply with the strategy, a notification that the user purchased the stock and that the characteristics of the stock do not comply with the strategy.

13. The system of claim 1, wherein the item is a website comprising characteristics of stocks; and
wherein the at least one processing device is configured to:
determine, based on the eye-tracking data, a characteristic of a stock on which the user focused, wherein the action, performed by the user, regarding the item comprises at least one of the user selling the stock or the user not purchasing the stock;
determine other stocks having the characteristic on which the user focused; and
when adjusting information associated with the next interaction with the user, adjust the information to at least one of comprise information recommending the user sell the other stocks or remove information identifying the other stocks.

14. The system of claim 13, wherein the user is a member of a group of other users; and
wherein the at least one processing device is configured to:
provide, to the other users of the group, a notification requesting confirmation that the characteristic on which the user focused is of concern;
receive, from one or more of the other users of the group, confirmation that the characteristic on which the user focused is of concern; and
provide, based on receiving the confirmation and to the other users of the group, the information identifying the other stocks.

15. The system of claim 1, wherein the item is a website comprising characteristics of stocks; and
wherein the at least one processing device is configured to:
determine, based on the eye-tracking data, a characteristic of a stock on which the user focused, wherein the action, performed by the user, regarding the item comprises the user selling the stock;
determine, based on the user selling the stock, whether characteristics of the stock comply with a strategy; and
provide, to another user and based on determining that the characteristics of the stock do not comply with the strategy, a notification that the user sold the stock and that the characteristics of the stock do not comply with the strategy.

16. A computer program product for tracking user eye focus for adjusting interactions with a user, the computer program product comprising a non-transitory computer-readable medium comprising code causing a first apparatus to:
receive, from a user device, image data associated with an item;
receive, from the user device, eye-tracking data associated with eye movements of a user while the user is viewing the item;
determine, based on the eye-tracking data, whether the user focused on the item;
receive outcome data comprising an action, performed by the user, regarding the item;
determine, based on the outcome data and based on whether the user focused on the item, an attribute of the action by determining at least one of:
whether the user understood the item; or
whether the user took the action regarding the item impulsively;
adjust, based on the attribute of the action, information associated with a next interaction with the user; and
cause the user device to provide, to the user and during the next interaction, the adjusted information.

17. The computer program product of claim 16, wherein the non-transitory computer-readable medium comprises code causing the first apparatus to:
determine, based on the image data, characteristics of the item;
when determining whether the user focused on the item, determine a characteristic, of the characteristics of the item, on which the user focused; and
when adjusting the information associated with the next interaction with the user, adjust the information to include another item having the characteristic on which the user focused.

18. The computer program product of claim 16, wherein the non-transitory computer-readable medium comprises code causing the first apparatus to, when determining whether the user focused on the item:
determine an amount of time that a gaze of the user is directed to the item; and
determine, based on the amount of time satisfying a threshold, that the user focused on the item.

19. The computer program product of claim 16, wherein the non-transitory computer-readable medium comprises code causing the first apparatus to receive the outcome data from at least one of:
the user device;
a point of sale system; or
a data structure comprising information regarding resource distributions associated with the user.

20. A method for tracking user eye focus for adjusting interactions with a user, the method comprising:
receiving, from a user device, image data associated with an item;
receiving, from the user device, eye-tracking data associated with eye movements of a user while the user is viewing the item;
determining, based on the eye-tracking data, whether the user focused on the item;
receiving outcome data comprising an action, performed by the user, regarding the item;
determining, based on the outcome data and based on whether the user focused on the item, an attribute of the action by determining at least one of:
whether the user understood the item; or
whether the user took the action regarding the item impulsively;
adjusting, based on the attribute of the action, information associated with a next interaction with the user; and
causing the user device to provide, to the user and during the next interaction, the adjusted information.
